(19) United States
(12) Patent Application Publication
(10) Pub. No.: US 2005/0118992 A1
(43) Pub. Date: Jun. 2, 2005

(54) Method of transmitting and receiving service availability information about a multimedia broadcast/multicast service

(75) Inventors: Kyeong-In Jeong, Suwon-si (KR); Sung-Ho Choi, Suwon-si (KR); Kook-Heui Lee, Yongin-si (KR); Gert Jan Van Lieshout, Apeldoom (NL)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/957,346

(22) Filed: Oct. 1, 2004

(30) Foreign Application Priority Data
Oct. 2, 2003 (KR) 2003-68949

(51) Int. Cl. H04Q 7/20

(52) U.S. Cl. 455/422.1; 455/432.1; 455/452.1

(57) ABSTRACT

A method of transmitting and receiving MBMS service availability information. To support the mobility of UEs receiving an MBMS service, an RNC transmits, to each of a plurality of cells under its control, an MBMS service availability message including service availability information and resource availability information regarding at least one MBMS service available in the cell. From the MBMS service availability message, a UE determines if a desired MBMS service can be received in a current cell currently or in the future. The UE requests the desired MBMS service or selects another cell capable of providing the MBMS service.

### PRIORITY

This application claims priority under 35 U.S.C. § 119 to an application entitled “Method of Transmitting/Receiving Service Availability Information about Multimedia Broadcast/Multicast Service” filed in the Korean Intellectual Property Office on Oct. 2, 2003 and assigned Serial No. 2003-68949, the contents of which are incorporated herein by reference.

### BACKGROUND OF THE INVENTION

1. Field of the Invention

The present invention relates generally to a method of providing an MBMS (Multimedia Broadcast/Multicast Service) service in a mobile communication system, and in particular, to a method of transmitting and receiving service availability information about an MBMS service in order to support UE (User Equipment) mobility.

2. Description of the Related Art

In addition to a basic voice service, recent communication technology and growing user demands have driven the development of CDMA (Code Division Multiple Access) mobile communication systems for transmitting a large volume of data through circuit communication and packet communication in a multimedia multicast service. To support multimedia multicast communications, the 3^{rd} generation standardization groups have presented a variety of criteria for providing an MBMS in which the same data is transmitted to multiple UEs.

FIG. 1 illustrates a conventional MBMS mobile communication system. More specifically, FIG. 1 illustrates a GSM (Global System for Mobile Communications)/GPRS (General Packet Radio Services)-based system that provides an MBMS service under the 3^{rd} generation asynchronous mobile communication standards of the 3GPP (3^{rd} Generation Project Partnership).

Referring to FIG. 1, UEs 101 to 108 are devices capable of receiving MBMS data. Cells 111, 112, and 113 are the coverage areas of a Node B 121, which provides service to the UEs 101 to 108. More specifically, the Node B 121 exchanges radio signals with wired signals according to the 3GPP standards, and provides MBMS to the UEs 101 to 108 within the cells 111, 112, and 113.

An RNC (Radio Network Controller) 131 manages a plurality of Node Bs. More specifically, the RNC 131 controls radio channels established between UEs and Node Bs supporting MBMS, including the Node B 121, in order to provide MBMS data to the Node Bs. The RNC 131 and the Node B 121 collectively form a UTRAN (UMTS Terrestrial Radio Access Network). The UTRAN.connects the UEs 101 to 108 to a CN (Core Network).

An SGSN (Serving GPRS Support Node) 141 controls an MBMS service for each MBMS subscriber. For example, the SGSN 141 manages billing data for each subscriber and selectively provides multimedia data to a particular RNC. An HLR (Home Location Register) 151, which is connected to the SGSN 141, authenticates subscribers. A GGSN (Gateway GPRS Support Node) 161 receives MBMS data destined for the UEs 101 to 108 from a content provider 191 and multicast/broadcast sources 192 and 193 via a BM-SC (Broadcast/Multicast Service Center) 181 and a BG (Border Gateway) 171, provides the MBMS data to the SGSN 141, manages the mobility of the UEs 101 to 108, and manages the QoS (Quality of Service) of the MBMS service for the UEs 101 to 108. The contents provider 191 and the multicast/broadcast sources 192 and 193 are the sources of the MBMS data transmission.

The BG 171 provides the GGSN 161 with the MBMS data received from the multicast[broadcast source 192 in a network that is not controlled by the present service provider. The BM-SC 181 provides the GGSN 161 with MBMS data received from the contents provider 191, authenticates the contents provider 191, determines the MBMS QoS, compensates for MBMS data loss, charges for the contents from the contents provider 191, and notifies the UEs 101 to 108 of on-going MBMS services.

MBMS data streams are delivered to the GGSN 161 directly from the multicast/broadcast source 193 within the network, from the contents provider 191 via the BM-SC 181, or from the multicast/broadcast source 192 via the BG 171. The UEs 101 to 108 receive the MBMS data streams via the Node B 121 under the control of the SGSN 141 and the RNC 131.

Although not shown, a plurality of SGSNs may be connected to one MBMS service, each SGSN having a plurality of RNCs. Each SGSN selectively transmits data to RNCs and each RNC selectively transmits data to Node Bs. Accordingly, the SGSN has a list of RNCs to receive data and the RNC has a list of Node Bs to receive data.

FIG. 2 is a diagram illustrating a signal flow for a conventional MBMS service procedure. For better understanding of the MBMS service procedure in a particular cell, only signal flows among a UE 201, an RNC 211, and an SGSN 221 are illustrated.

Referring to FIG. 2, the SGSN 221 provides basic information about MBMS services to the UE 201 via the RNC 211, e.g., what the MBMS services are and whether they are available, in step 231 (Announcement). If there is a desired MBMS service among the MBMS services, the UE 201 notifies the SGSN 331 through the RNC 211 that it will join the desired MBMS service in step 241 (Joining). In the Joining step 241, the UE 201 notifies the SGSN 221 the ID of the desired MBMS service. The SGSN 221 authenticates the UE 201 and notifies the UE 201 whether or not the MBMS service is available to the UE 201. The SGSN 221 stores a list of UEs requesting the MBMS service and their locations through the Joining.

When a BM-SC announces the initiation of the MBMS service that the UE 201 has joined, the SGSN 221 transmits a Session Start message to the RNC 211, which controls the UE 201, in step 251. In step 252, the RNC 211 transmits an MBMS Paging message to the UE 201 to notify the initiation of the MBMS service (Notification). The MBMS Paging message is transmitted to a plurality of UEs that have joined the MBMS service. Accordingly, the MBMS paging in step 252 is called “group paging” in order to be distinguishable from conventional paging.

In response to the MBMS paging, the UE 201 transmits a Notification Response message in step 261. The RNC 211 determines the number of UEs that are to receive the MBMS service and the type of a radio channel (i.e., service type) for the MBMS service in each cell. If the number of UEs to receive the MBMS service is at least equal to a predetermined threshold, the RNC 211 provides the MBMS service on a common channel in a point-to-multipoint (PtM) mode. However, if the number of UEs to receive the MBMS service is lower than the threshold, the RNC 211 provides the MBMS service in a point-to-point (PtP) mode by establishing an RRC (Radio Resource Control) connection and a dedicated channel with the individual UEs.

In step 271, the RNC 211 transmits MBMS radio bearer information to the UE 201. The MBMS radio bearer information includes information about the radio channel that delivers the MBMS service, for example, OVSF (Orthogonal Variable Spreading Factor) code information, transport format information, RLC (Radio Link Control) information, and PDCP (Packet Data Convergence Control) information. The UE 201 receives the MBMS service according to the MBMS radio bearer information in step 281.

The MBMS radio bearer information can be transmitted to all UEs receiving the MBMS service in the cell. Therefore, it is efficient to transmit MBMS service-related control signals on a common control channel established for the cell. The 3GPP specifies that the MBMS control signals are periodically transmitted on a logical channel called an MCCH (MBMS Control Channel).

A plurality of cells in which a UE may be located provide a particular MBMS service either by agreement with service providers or depending on the availability of radio resources. However, the UE cannot detect if a desired MBMS service is available or there are sufficient resources to provide the MBMS service in a cell that it now belongs to. Consequently, a UE may establish an RRC connection and request an MBMS service that is not available or for which there are not sufficient resources, resulting in unnecessary signaling overhead and increased service delay.

### SUMMARY OF THE INVENTION

Accordingly, the present invention has been designed to substantially solve at least the above problems and/or disadvantages and to provide at least the advantages below. An object of the present invention is to provide a method of informing a UE about service availability and resource availability regarding an MBMS service for each cell in an MBMS mobile communication system.

Another object of the present invention is to provide a method of enabling a UE to request an MBMS service or select another cell, after recognizing that it has entered a cell not supporting the MBMS service or having insufficient resources for the MBMS service in an MBMS mobile communication system.

A further object of the present invention is to provide a method of informing a UE about service availability of an MBMS service for each cell by notifying the UE whether the MBMS service is NSA (Not Service Availability), SA (Service Availability), or OSA (Out of Service Area) in an MBMS mobile communication system.

The above and other objects are achieved by providing a method of transmitting and receiving MBMS service availability information.

According to one aspect of the present invention, in a method of transmitting service availability information about an MBMS service to UEs within a plurality of cells in an RNC for controlling the MBMS service for the UEs, in a mobile communication system, the RNC determines if an MBMS service is available and if resources are sufficient for the MBMS service in each of the cells. The RNC transmits a paging message including service availability information and resource availability information to UEs within cells in which the MBMS service is available. The service availability information indicates if the MBMS service is available and the resource availability information indicates if resources are available for the MBMS service. The RNC transmits to the UEs within the plurality of cells a service availability message including resource availability information about at least one MBMS service available in each of the cells.

According to another aspect of the present invention, in a method of receiving service availability information about an MBMS service from an RNC controlling UEs in a plurality of cells in a UE to receive the MBMS service, the UE receives from the RNC a service availability message including service availability information and resource availability information about at least one MBMS service available in a cell where the UE is located. The service availability information indicates if the MBMS service is available and the resource availability information indicates if the cell has sufficient resources for the MBMS service. The UE determines from the service availability message if a desired MBMS service is available and if there are sufficient resources for the desired MBMS service in the cell. If the desired MBMS service is available and sufficient resources exist for the desired MBMS service in the cell, the UE receives the desired MBMS service in the cell.

### BRIEF DESCRIPTION OF THE DRAWINGS

The above and other objects, features, and advantages of the present invention will become more apparent from the following detailed description when taken in conjunction with the accompanying drawings in which:

FIG. 1 illustrates a conventional MBMS mobile communication system;

FIG. 2 is a diagram illustrating a signal flow for a conventional MBMS service procedure;

FIG. 3A and 3B illustrate transmission of MCCH control messages;

FIG. 4 illustrates a movement of a UE while receiving an MBMS service;

FIG. 5 is a diagram illustrating a signal flow for transmitting MBMS control information according to a preferred embodiment of the present invention;

FIG. 6 illustrates an MBMS Service Availability message on the MCCH according to a preferred embodiment of the present invention;

FIG. 7 is a flowchart illustrating an operation in an RNC for transmitting an MBMS Paging message according to a preferred embodiment of the present invention;

FIG. 8 is a flowchart illustrating an operation in an RNC for initially transmitting an MBMS Service Availability message according to a preferred embodiment of the present invention;

FIGS. 9A, 9B, and 10 are flowcharts illustrating an operation in a UE for determining service availability according to a preferred embodiment of the present invention; and

FIG. 11 is a flowchart illustrating an operation in an RNC for periodically transmitting an MBMS Service Availability message according to a preferred embodiment of the present invention.

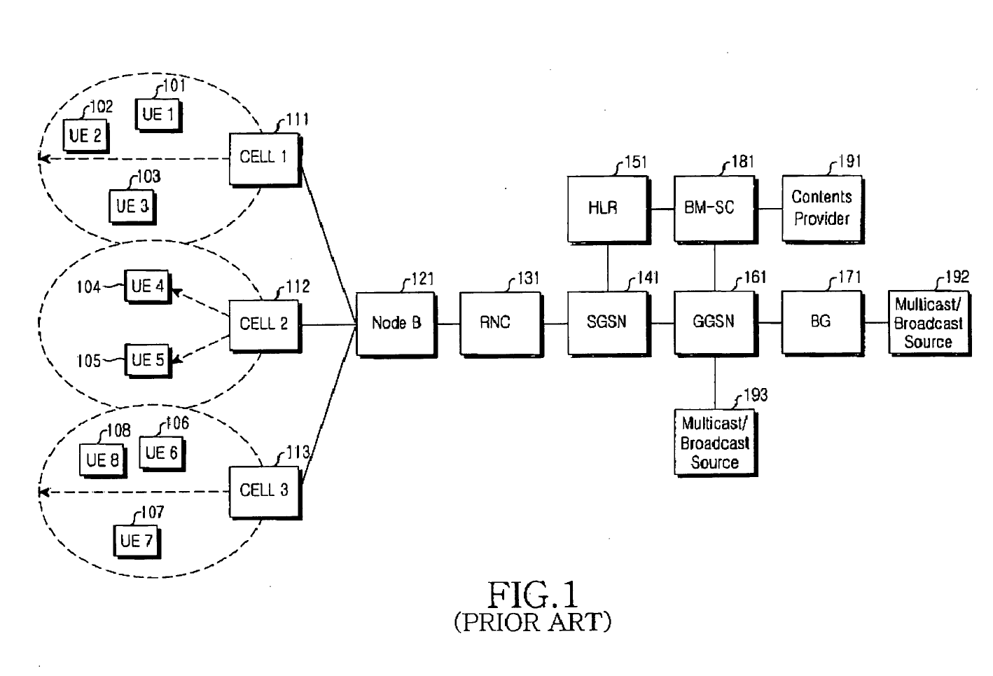

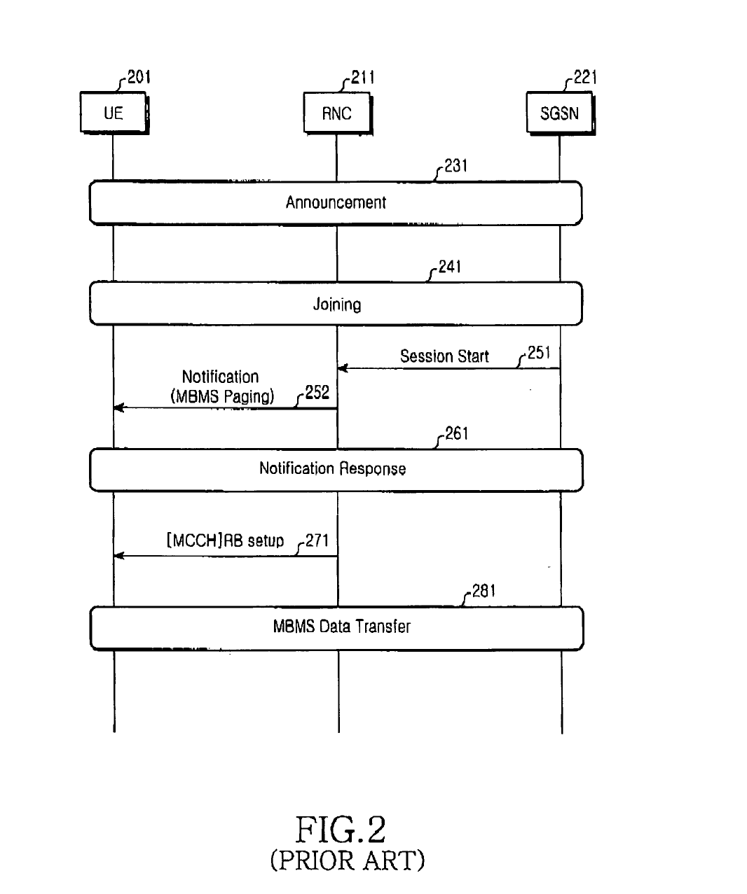

### DETAILED DESCRIPTION OF THE PREFERRED EMBODIMENT

Preferred embodiments of the present invention will be described in detail herein below with reference to the accompanying drawings. In the following description, well-known functions or constructions are not described in detail when they would obscure the invention in unnecessary detail.

The present invention, as will be described herein below, pertains to transmission of service availability information from an RNC to a UE by a periodic MBMS control message on an MCCH in an MBMS mobile communication system.

Typically, MBMS services are categorized into three types in a target cell that a UE moves to or a cell where the UE starts its communication: NSA (Not Service Availability), SA (Service Availability), or OSA (Out of Service Area). If the cell does not support a particular MBMS service, the MBMS service is NSA. Although the cell supports the MBMS service, it may not provide the MBMS service temporarily for a reason such as a lack of resources at current time. Then, the MBMS service is OSA. If the MBMS service is SA, the cell can provide the MBMS service.

If an MBMS service is NSA or OSA in a particular cell, a UE does not establish an RRC connection to request the MBMS service. More specifically, in the case of NSA, the cell cannot provide the MBMS service. Therefore,,there is no need for MBMS paging. However, in the case of OSA, if resources become available, the cell is capable of providing the MBMS service. In this case, the MBMS paging is needed.

If the MBMS service is SA, it is ongoing in a PtP or PtM mode in the cell, or while the MBMS service is not being provided due to the absence of any UE requesting the MBMS service, the cell can start the MBMS service immediately upon a request from a UE. An MCCH control message includes information indicating whether an MBMS service is SA, NSA, or OSA in a particular cell at the initiation of the MBMS service or during a current MBMS service.

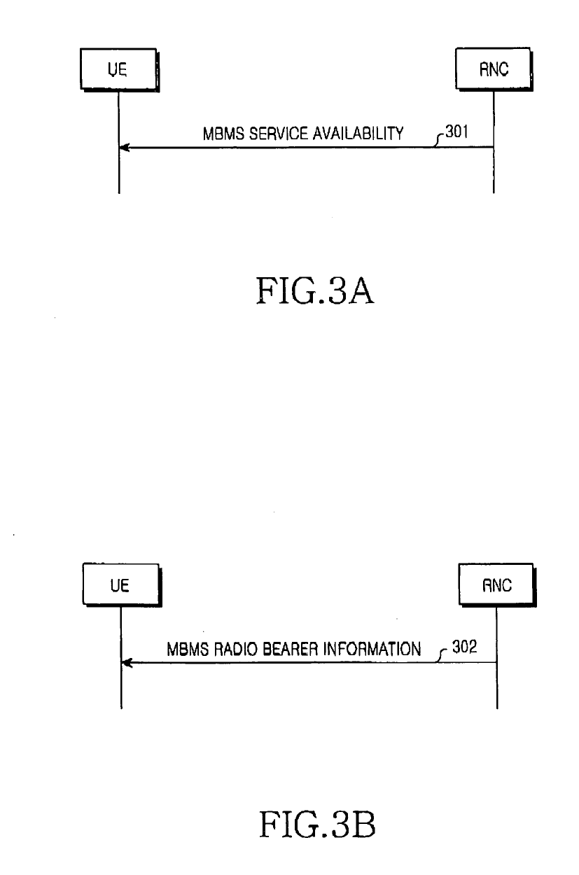

FIGS. 3A and 3B illustrate MCCH control messages for supporting UE mobility during an MBMS service. The MCCH control messages support the MBMS service for the UE when it is in a PMM (Packet Mobility Management) idle mode or a PMM connected mode.

FIG. 3A illustrates transmission of an MBMS Service Availability message 301. The MBMS Service Availability message 301, which is transmitted from an RNC to a UE, informs the UE about the availability of an MBMS service during the MBMS service. The MBMS Service Availability message 301 includes the availability information of at least one MBMS service available in the cell, and MBMS service identifiers (IDs) and their service types.

FIG. 3B illustrates transmission of an MBMS Radio Bearer Information message 302. The Radio Bearer Information message 302 is used by the RNC to notify the UE of the radio bearer information of an MTCH (MBMS Traffic Channel) that delivers MBMS data. When an MBMS service is provided in a Ptp mode, a radio bearer is established for each UE. However, it is impossible to notify individual UEs of the radio bearer information on the MCCH. Accordingly, the radio bearer information of the Radio Bearer Information message 302 is valid only for an MBMS service provided in a PtM mode. The Radio Bearer Information message 302 contains an MBMS service ID and logical channel/transport channel/physical channel information.

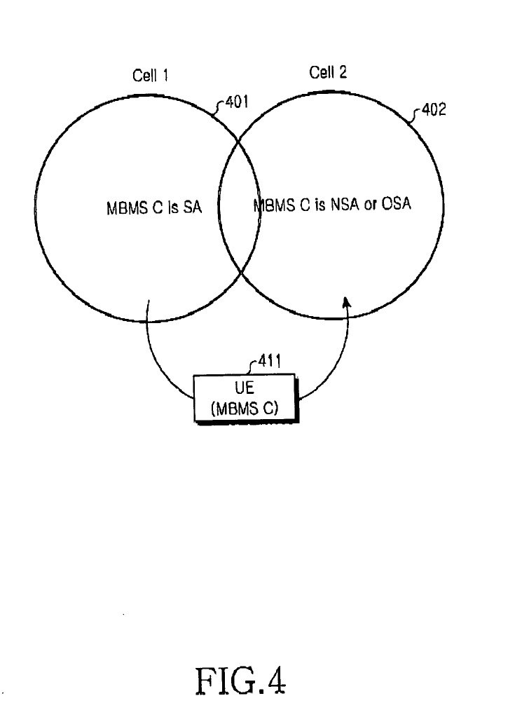

FIG. 4 illustrates the movement of a UE during receiving an MBMS service. Reference numerals 401 and 402 denote cell 1 and cell 2, respectively, and reference numeral 411 denotes a UE that moves from cell 1 to cell 2. Cell 1 supports an MBMS service C (MBMS C), and cell 2 does not support MBMS C or does not currently have sufficient resources for MBMS C, even though it is capable of providing MBMS C. Therefore, MBMS C is SA for cell 1 and NSA or OSA for cell 2. Because MBMS C is NSA or OSA for cell 2, the UE 411 selects another cell capable of providing MBMS C without an unnecessary RB connection and service requesting, or stays in cell 2. In cell 2, if the MBMS C is NSA, the UE 411 operates according to system setting or a user request.

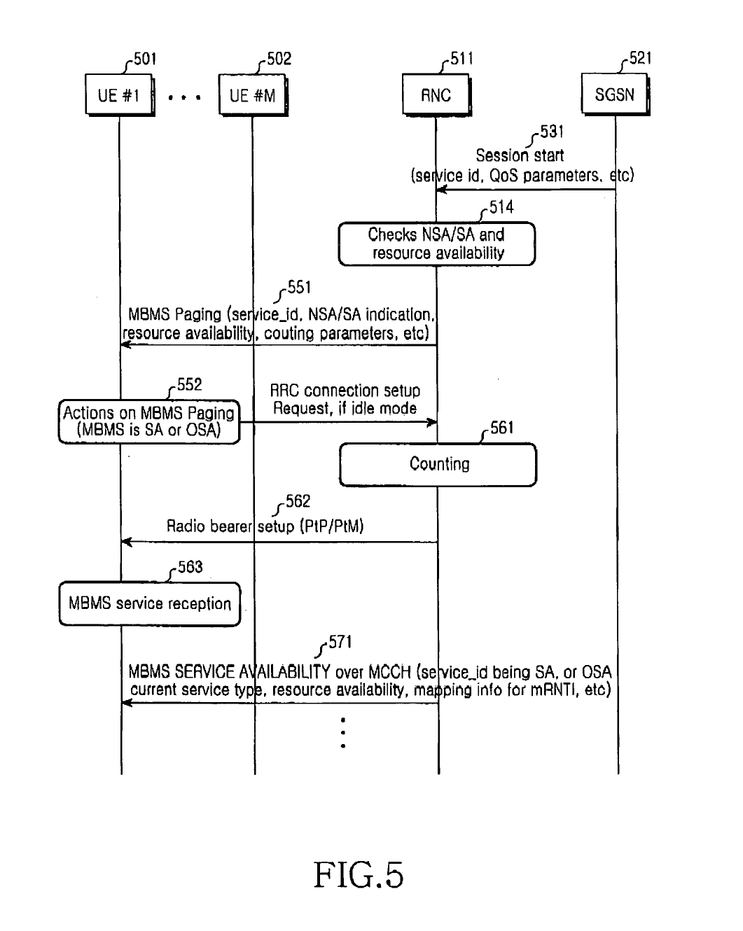

FIG. 5 is a diagram illustrating a signal flow for an operation for transmitting MBMS service availability information to a UE on the MCCH according to a preferred embodiment of the present invention. Reference numerals 501 and 502 denote UE 1 and UE M that are receiving an MBMS service, reference numeral 511 denotes an RNC that controls the radio connections of UE 1 and UE M, and reference numeral 521 denotes an SGSN that controls the RNC 511. While both UE 1 and UE M have joined the same MBMS service, UE 1 is located in a cell for in the MBMS service is SA or OSA, and UE M is located in a cell in which the MBMS service is NSA.

Referring to FIG. 5, the RNC 511 receives a Session Start message regarding the MBMS service from the SGSN 521 in step 531. Because the Session Start message includes the ID and QoS of the MBMS service and other parameters, the RNC 511 determines whether each of cells under its control is NSA, SA, or OSA from the parameters in step 541. Simultaneously, the RNC 511 determines resource availability for the MBMS service in each cell. Unless an OVSF code satisfying the QoS set in the Session Start message is currently available in a cell, the RNC 511 determines that resources are insufficient for the MBMS service in the cell.

In step 551, the RNC 511 transmits an MBMS Paging message regarding the MBMS service to UE 1 on an MBMS-related paging channel. The MBMS Paging message indicates the generation of an event such as the session start for the MBMS service, and includes the ID of the MBMS service, a cause value, an NSA/SA indicator, a resource availability indicator, and parameters required for counting valid UEs to receive the MBMS service. The cause value indicates that the MBMS Paging message has been generated in response to the Session Start message. The counting parameters can be further included as optional values (OVs) or conditional values (CVs) in the MBMS Paging message. The NSA/SA indicator and the resource availability indicator are set according to the resource and service states of the cell to which the MBMS Paging message is transmitted, in order to indicate whether the cell is SA, NSA, or OSA. The MBMS Paging message can be transmitted during the MBMS service in progress, and includes corresponding parameters according to the service event and the type of an MBMS control message to receive.

If the MBMS service is OSA in a cell, the MBMS Paging message includes the ID of the MBMS service, the cause value, the NSA/SA indicator, and the resource availability indicator. If the MBMS service is SA in the cell, the MBMS Paging message includes all the afore-described parameters.

In a cell for which the MBMS service is SA or OSA, a UE operates according to the MBMS service ID and the cause value set in the MBMS Paging message, and its connection state.

If a desired MBMS service is NSA and cell reselection is possible, the UE selects another cell capable of providing the MBMS service and moves to the another cell. However, if cell reselection is impossible and there is not any other desired MBMS service, the UE stays in the cell and ends reception of the MBMS service.

If the desired MBMS service is OSA and cell reselection is possible, the UE selects another cell capable of providing the MBMS service and moves to the another cell. If the desired MBMS service is OSA and cell reselection is impossible, the UE receives the MCCH in the cell and waits until MBMS resources are available. Alternatively, the UE can end the MBMS service in the cell upon user request. By receiving the MBMS Paging message or additionally receiving an MBMS Service Availability message on the MCCH through scheduling, the UE can determine if the MBMS resources are available, that is, when the MBMS service becomes SA in the cell.

For example, UE 1, which is in an idle mode within a cell for which the MBMS service is SA, transmits an RRC Connection Setup Request message in response to the MBMS Paging message to the RNC 511 to receive the MBMS service, in step 552. If it is necessary to count valid UEs, the RNC 511 counts UEs to receive the MBMS service within the cell and determines the service type of the MBMS service according to the count and radio bearer information according to the service type in step 561. In step 562, the RNC 511 transmits the determined radio bearer information to UE 1 by a Radio Bearer Setup message. When a radio bearer setup is completed, UE 1 can receive the MBMS service in step 563.

After the initiation of the MBMS service, the RNC 511 periodically transmits the MBMS Service Availability message indicating whether the MBMS service is NSA, OSA, or SA on the MCCH in order to support the mobility of UEs moving between cells during the MBMS service. The MBMS Service Availability message includes the ID of the MBMS service, resource availability information, a current service type, and mapping information between the MBMS service ID and mRNTI (MBMS Radio Network Temporary Identifier).

If the ID of a desired MBMS service is not found in the MBMS Service Availability message, the MBMS service is not available in the cell (NSA).

The UE also determines from the resource availability information whether the MBMS service is OSA or SA. If the MBMS service is SA, the MBMS Service Availability message includes the service type of the MBMS service. The service type indicates whether the MBMS service is provided in a PtP or PtM mode, or if no UEs request the MBMS service within the cell (no UE).

In the case of PtM, the UE detects the radio bearer information from the Radio Bearer Information message received on the MCCH and receives the MBMS service on the MTCH according to the radio bearer information. In the case of PtP, the UE establishes an RRC connection and requests the MBMS service. In the case of no UE, the UE establishes the RRC connection and requests the MBMS service, or operates as otherwise specified. If the UE operates in the same manner in both case of PtP and no UE, the volume of transmitted information can be reduced by replacing the service type by a PtM indicator.

As described above, when the UE enters a particular cell, it determines if a desired MBMS service is NSA, OSA, or SA from the MBMS Service Availability message received from the cell. If the MBMS service is SA, the UE determines its service type. If the MBMS service is NSA, the UE selects another Node B where the MBMS service is available, or ends reception of the MBMS service in the current cell. If the MBMS service is OSA, the UE selects another Node B where the MBMS service is available, or receives the MCCH periodically and checks resource availability, until resources are available for the MBMS service in the cell. If the MBMS service is SA, the UE operates according to its service type.

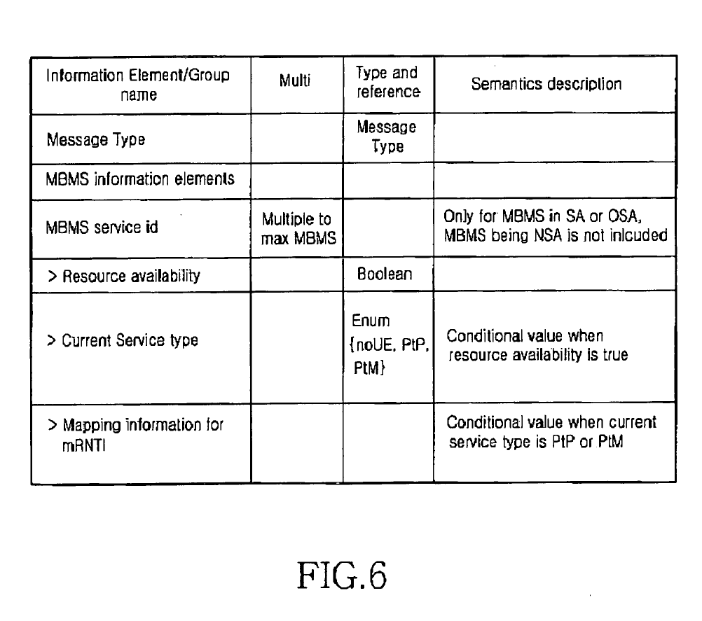

FIG. 6 illustrates an MBMS Service Availability message transmitted on an MCCH according to the embodiment of the present invention. As illustrated in FIG. 6, the MBMS Service Availability message includes Message Type and at least one or more IEs (Information Elements) for an MBMS service being SA or OSA.

Referring to FIG. 6, the IEs include MBMS Service ID, Resource Availability, Current Service Type, and Mapping Information for mRNTI. The Current Service Type is set to no UE, PtP, or PtM, or it can be a PtM Indicator. The Current Service Type can be conditional, such that it is included only when resources are available. The Mapping Information for MRNTI is included only when the Current Service Type is PtP or PtM. Thus, it is also conditional. The Resource Availability indicates whether resources are available or not by using one bit, or is set to describe the resource availability for the MBMS service. The Resource Availability will be described in more detail herein below.

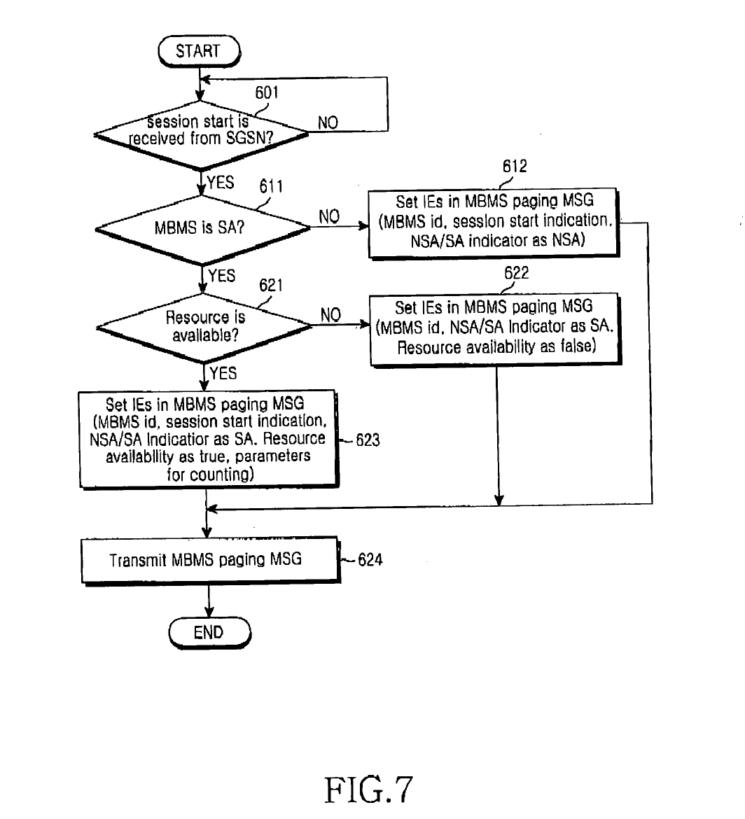

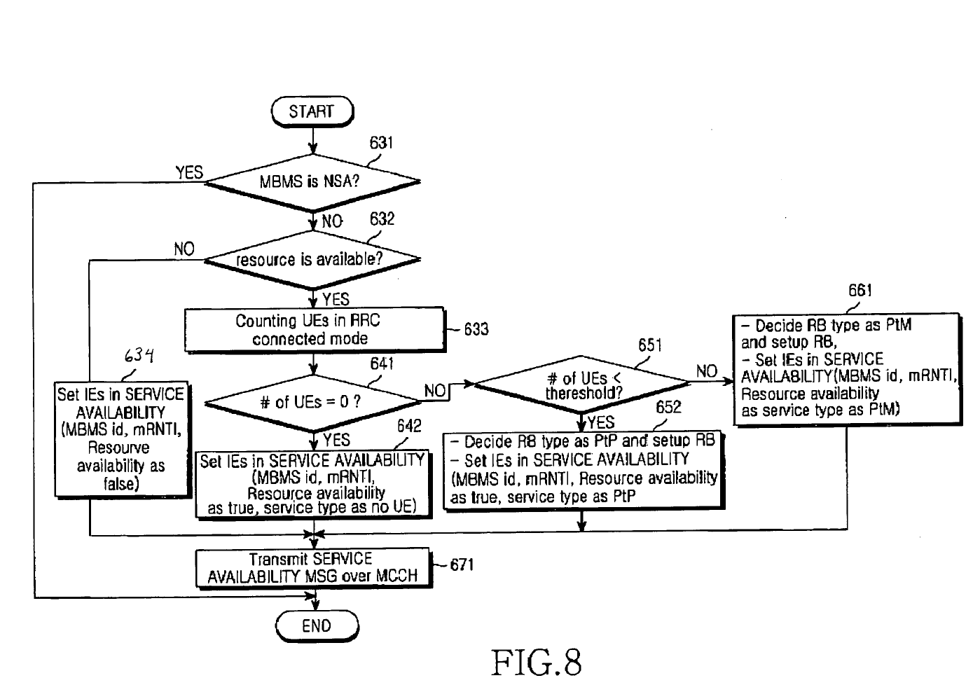

FIGS. 7 and 8 are flowcharts illustrating an operation in an RNC for transmitting the MBMS Paging Message and the MBMS Service Availability message according to a preferred embodiment of the present invention. Referring to FIG. 7, upon receiving a Session Start message for a particular MBMS service from the SGSN in step 601, the RNC determines if the MBMS service is SA in each cell under its control in step 611. The determination is made according to parameters included in the Session Start message, not according to resource availability for the MBMS service.

If the MBMS service is not SA, the RNC sets the ID of the MBMS, a cause value indicating the session start, and an NSA/SA indicator indicating NSA in the MBMS Paging message in step 612 and transmits the MBMS Paging message in step 624. It can be further contemplated as another embodiment of the present invention that the RNC does not transmit the MBMS Paging message to cells for which the MBMS service is NSA.

However, if the MBMS service is SA, the RNC checks if resources are available for the MBMS service in the cell in step 621. That is, the RNC determines if resources are sufficient to support the QoS of the MBMS service according to an MBMS QoS parameter set in the Session Start message.

If resources are not sufficient for the MBMS service, the RNC sets the ID of the MBMS service, the cause value indicating the session start, the NSA/SA indicator as SA, and a resource availability indicator as false (i.e., OSA) in the MBMS Paging message in step 622.

However, if sufficient resources exist for the MBMS service, the RNC sets the ID of the MBMS service, the cause value indicating the session start, the NSA/SA indicator as SA, and the resource availability indicator as true in the MBMS Paging message in step 623. When determining that it is necessary to count UEs requesting the MBMS service, the RNC includes parameters for counting the UEs in the MBMS Paging message. In step 624, the RNC transmits the MBMS Paging message set in step 612, 622, or 623.

FIG. 8 is a flowchart illustrating an initial transmission of an MBMS Service Availability message following the procedure illustrated in FIG. 7. Referring to FIG. 8, the RNC determines if the MBMS service is NSA in the cell in step 631. If the MBMS service is NSA, the RNC terminates the procedure without transmitting any message related to the MBMS service to the cell. However, if the MBMS service is not NSA, the RNC determines if the cell has resources enough to satisfy the QoS of the MBMS service in step 632.

If resources are insufficient, the RNC sets MBMS Service ID to the ID of the MBMS service, Resource Availability to false, and Mapping Information for mRNTI in the MBMS Service Availability message in step 634 and proceeds to step 671.

If the cell has sufficient resources in step 632, the RNC counts the number of UEs to receive the MBMS service in a connected mode in order to determine the radio bearer type of the MBMS service in the cell in step 633. The RNC determines if the count is 0 in step 641. If the count is 0, the RNC includes the ID of the MBMS service, the mRNTI mapping information, Resource Availability set to true, and Current Service Type set to no UE in the MBMS Service Availability message in step 642.

If the count is not 0, the RNC compares the count with a threshold preset to provide the MBMS service in a PtM mode in step 651. If the count is less than the threshold, the RNC determines the radio bearer type of the MBMS service as PtP and sets radio bearer information corresponding to the PtP mode in step 652. Accordingly, the MBMS Service Availability message includes the ID of the MBMS service, the mRNTI mapping information, Resource Availability set to true, and Current Service Type set to PtP.

However, if the count is equal to or greater than the threshold, the RNC sets the radio bearer type of the MBMS service as PtM and sets radio bearer information corresponding to the PtM mode in step 661. The MBMS Service Availability message includes the ID of the MBMS service, the mRNTI mapping information, Resource Availability set to true, and Current Service Type set to PtM.

The MBMS Service Availability message set in step 634, 642, 652, or 661 is transmitted on the MCCH in step 671. Although not shown, the PtM radio bearer information determined in step 661 is transmitted on the MCCH by a Radio Bearer Information message and the PtP radio bearer information determined in step 642 or 652 is transmitted on a control channel by the Radio Bearer Information message.

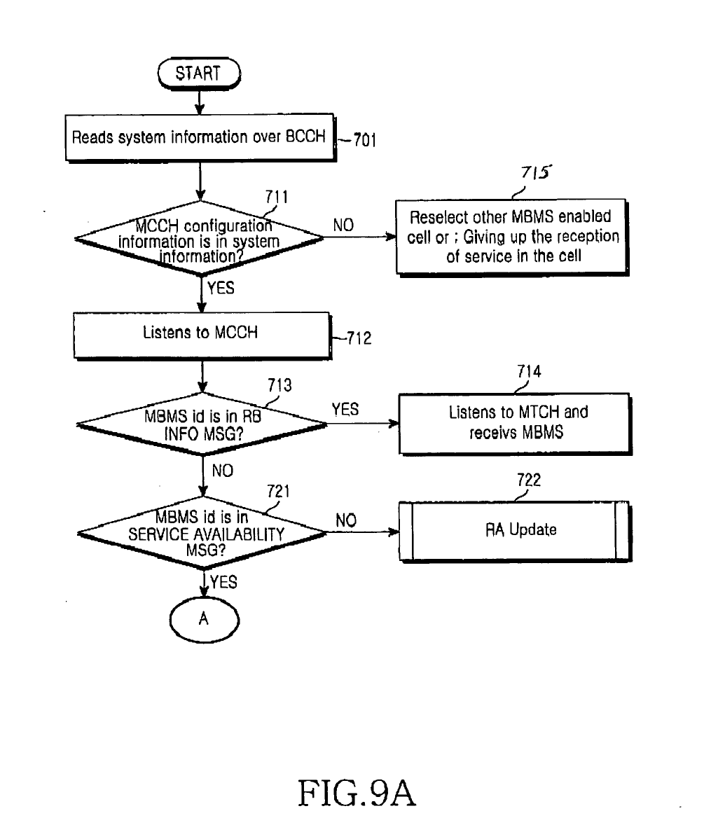

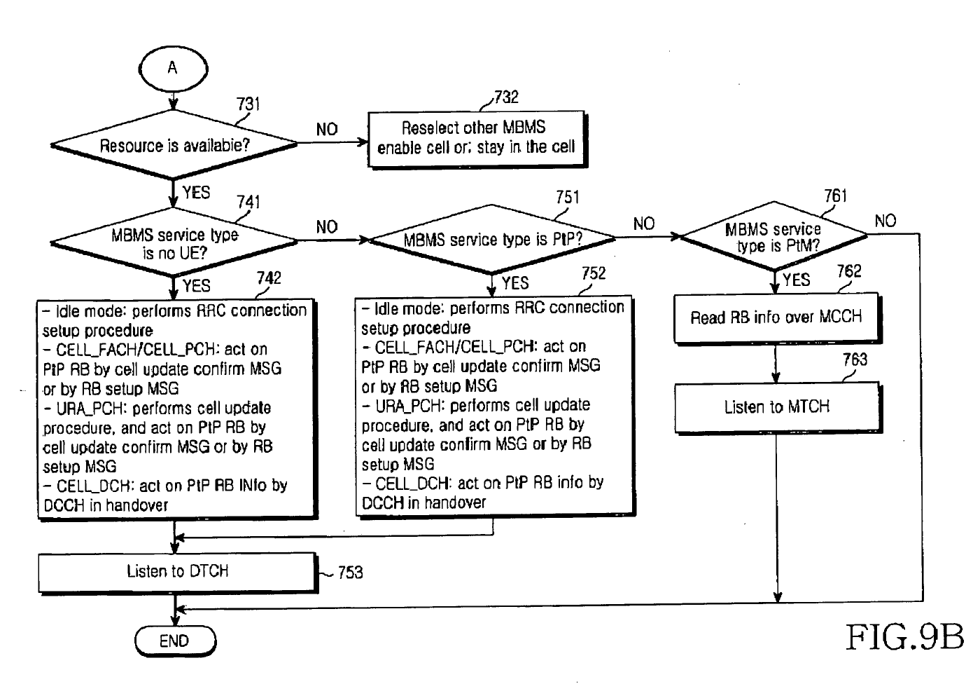

FIGS. 9A and 9B are flowcharts illustrating an operation in the UE for receiving an MBMS Service Availability message according to an embodiment of the present invention. The receiving operation is performed when the MS reselects a cell while roaming. That is, the operations illustrated in FIGS. 9A and 9B are performed at each cell reselection, irrespective of a session start.

Referring to FIGS. 9A and 9B, as the UE enters a particular cell through cell reselection, and reads system information received on a BCCH (Broadcast Control Channel) in step 701. In step 711, the UE determines if the system information includes MCCH configuration information. If the MCCH configuration information is not included in the system information, the UE determines that the current cell is a non-MBMS service area (NMA) that does not support a desired MBMS service in step 715. Therefore, the UE selects another cell supporting the MBMS service or ends reception of the MBMS service. In order to prevent unnecessary power consumption, the UE neither requests the desired MBMS service by establishing an RRC connection nor monitors an MBMS-related paging channel.

However, if the UE detects the MCCH configuration information from the system information, it connects to the MCCH based on the MCCH configuration information and receives an MBMS Radio Bearer Information message and/or an MBMS Service Availability message in step 712. In step 713, the UE determines if the MBMS Radio Bearer Information message includes the ID of the desired MBMS service. If the MBMS Radio Bearer Information message includes the ID of the desired MBMS service, the UE receives data of the MBMS service on the MTCH in step 714.

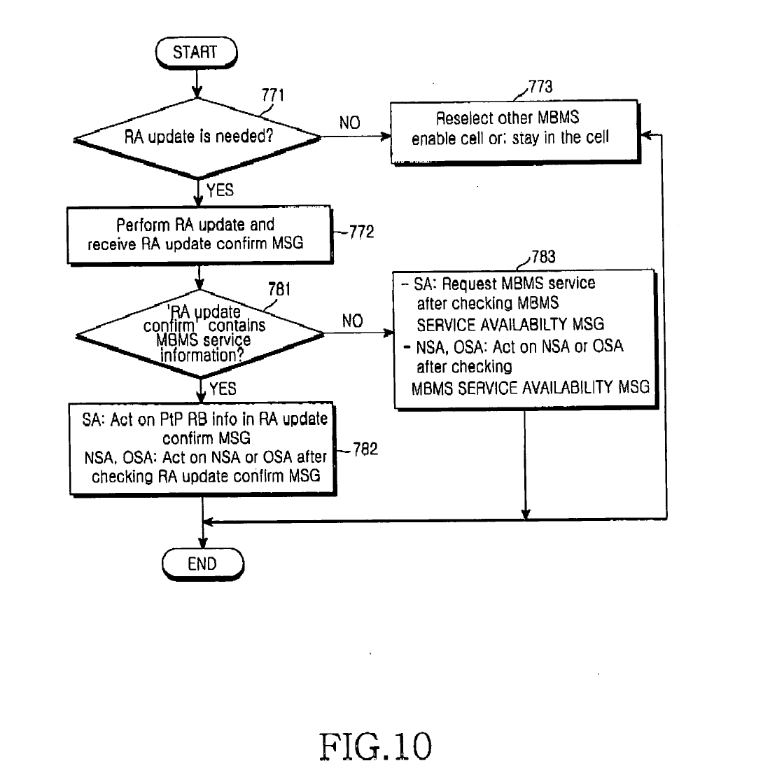

However, if the MBMS Radio Bearer Information message does not include the ID of the MBMS service, the UE checks if the MBMS Service Availability message includes the ID of the MBMS service in step 721. If the MBMS Service Availability message does not include the ID of the MBMS service , the UE updates its routing area (RA) when necessary in step 722. The RA update will be described in more detail later with reference to FIG. 10.

If the MBMS Service Availability message includes the ID of the MBMS service, the UE reads Resource Availability from the MBMS Service Availability message in step 731. If Resource Availability is false, the UE determines that the MBMS service is OSA in the cell in step 732. Then the UE selects another cell capable of providing the MBMS service or stays in the cell until the MBMS service is available. To determine the availability of the MBMS service, the UE monitors the MBMS-related paging channel.

If Resource Availability is true in step 731, the UE determines if Current Service Type is no UE in the MBMS Service Availability message in step 741. If Current Service Type is no UE, the UE performs an operation corresponding to its current state in step 742. More specifically, in an idle mode, the UE enters a connection mode by an RRC connection setup procedure. In the connection mode, the UE operates according to the UE state.

More specifically, if the UE is in a CELL_FACH state, in which it monitors an FACH (Forward Access Channel), or CELL_PCH state, in which it monitors a PCH (Paging Channel), the UE acquires PtP radio bearer information by receiving a Cell Update Confirm message or a Radio Bearer Setup message. In a URA_PCH (UTRAN Registration Area_Paging Channel) state in which a cell update occurs less frequently than in the CELL_PACH state, the UE performs the cell update and acquires PtP radio bearer information by a Cell Update Confirm message or a Radio Bearer Setup message received through the cell update procedure. Finally, in a CELL_DCH state in which the UE monitors a DCH (Dedicated Channel), the UE implements a handover procedure and receives PtP radio bearer information on a dedicated control channel during the handover procedure.

However, if Current Service Type is not no UE in step 741, the UE determines if Current Service Type is PtP in step 751. If Current Service Type is PtP in step 751, the UE operates in correspondence with its current state in step 752. More specifically, in the idle mode, the UE enters the connected mode through the RRC connection setup. In the connected mode, the UE operates according to its connected state. For example, in the CELL_FACH or CELL_PCH state, the UE acquires the PtP RB information by a Cell Update Confirm message or a Radio Bearer Setup message. In the URA_PCH state, the UE performs the cell update procedure and acquires the PtP RB information by a Cell Update Confirm message or a Radio Bearer Setup message received through the cell update procedure. In the CELL_DCH state, the UE receives PtP radio bearer information by a handover.

In step 753, the UE receives data of the MBMS service on a DTCH (Dedicated Traffic Channel) using the PtP radio bearer information acquired in step 742 or 752.

If Current Service Type is not PtP in step 751, the UE determines if Current Service Type is PtM in step 761. If Current Service Type is not PtM, the UE terminates the procedure, considering that an error has been generated.

When the Current Service Type is not PtM, the UE receives a Radio Bearer Information message including PtM radio bearer information on the MCCH in step 762 and receives the MBMS service on the MTCH activated by the PtM radio bearer information in step 763.

FIG. 10 is a flowchart illustrating an RA update in a UE according to a preferred embodiment of the present invention. Referring to FIG. 10, if a desired MBMS service is NSA, the UE determines if an RA update is needed in step 771. This determination is made according to whether the current cell and the previous cell are in different RAs. If the RA update is not needed, the UE selects another cell supporting the MBMS service or stays in the current cell in step 773. The UE periodically monitors an MBMS-related paging channel to determine if the MBMS service starts in the current cell.

If the RA update is needed, the UE transmits an RA Update Request message to the RNC and awaits reception of an RA Update Confirm message from the RNC in step 772.

In step 781, the UE determines if the RA Update Confirm message includes MBMS service information. The MBMS service information refers to all information set in the MBMS Service Availability message and the MBMS Radio Bearer Information message. That is, the MBMS service information may include the IDs, service types and PtP radio bearer information of MBMS services being SA. If the MBMS service information is found in the RA Update Confirm message, the UE determines that a desired MBMS service is SA, NSA, or OSA according to the MBMS service information in step 782. If the MBMS service is NSA or OSA, the UE correspondingly operates. If the MBMS service is SA, the UE sets up a PtP radio bearer based on the PtP radio bearer information included in the RA Update Confirm message, and then receives the MBMS service.

If the MBMS service information is not found in the RA Update Confirm message in step 781, the UE determines that the MBMS service is SA, NSA, or OSA according to the first MBMS Service Availability message received after the RA Update Confirm message in step 783. That is, if the MBMS service is NSA or OSA, the UE correspondingly operates. If the MBMS service is SA, the UE requests the MBMS service. When receiving the Radio Bearer Setup message including the PtP radio bearer information regarding the MBMS service before step 783, the UE receives the MBMS service according to the PtP radio bearer information.

If the MBMS service Availability message received after the RA update illustrated in FIG. 10 does not have the ID of the MBMS service, the UE considers that there is no need for performing the RA update again, which prevents repetition of unnecessary RA updating.

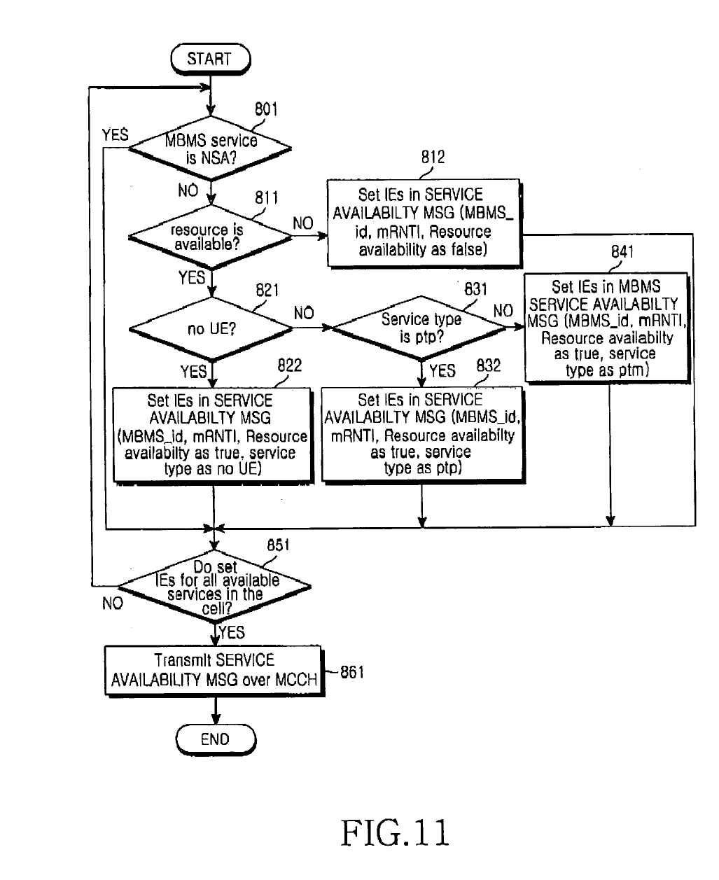

FIG. 11 is a flowchart illustrating an operation in an RNC for periodically transmitting an MBMS Service Availability message during an MBMS service according to an embodiment of the present invention. Referring to FIG. 11, the RNC determines if a particular MBMS service is NSA in each cell under its control in step 801. If the MBMS service is NSA, the RNC proceeds to step 851. If the MBMS service is not NSA, the RNC determines if the cell has sufficient resources for the MBMS service in step 811.

If there is a lack of resources for the MBMS service, the RNC sets the ID of the MBMS service, mRNTI mapping information, and Resource Availability as false in an MBMS Service Availability message in step 812.

If there are sufficient resources for the MBMS service, the RNC determines if any UE is to receive the MBMS service in the cell in step 821. If no UEs are to receive the MBMS service, the RNC sets the ID of the MBMS service, the mRNTI mapping information, Resource Availability set as true, and Current Service Type as no UE in the MBMS Service Availability message in step 822. If at least one UE is to receive the MBMS service in the cell, the RNC determines if the service type of the MBMS service is PtP according to the number of UEs to receive the MBMS service in step 831.

In the case of PtP, the RNC sets the ID of the MBMS service, the mRNTI mapping information, Resource Availability as true, and Current Service Type as PtP in the MBMS Service Availability message in step 832. If the service type of the MBMS service is not PtP, the RNC sets the ID of the MBMS service, the mRNTI mapping information, Resource Availability as true, and Current Service Type as PtM in the MBMS Service Availability message in step 841.

The RNC determines if the availability information of all available MBMS services in the cell is completely set in the MBMS Service Availability message in step 851, because the MBMS Service Availability message includes as many pieces of availability information as the number of available MBMS services in the cell. In step 861, the RNC transmits the MBMS Service Availability message.

As described above, according to the present invention, in an MBMS mobile communication system, a UE determines from MCCH control messages if a desired MBMS service is serviceable and resources are available for a desired MBMS service in a current cell. Also, the continuity of reception of the MBMS service is improved during roaming of the UE. The UE selectively establishes an RRC connection only when the MBMS service is available in the cell, thereby reducing signaling overhead caused by an unnecessary RRC connection.

While the present invention has been shown and described with reference to certain preferred embodiments thereof, it will be understood by those skilled in the art that various changes in form and details may be made therein without departing from the spirit and scope of the present invention as defined by the appended claims.

1. A method of transmitting service availability information about an MBMS (Multimedia Broadcast/Multicast Service) service to UEs (User Equipments) within a plurality of cells of an RNC (Radio Network Controller) for controlling the MBMS service for the UEs, in a mobile communication system, the method comprising the steps of:
determining if the MBMS service is available and if resources are sufficient for the MBMS service in each of the plurality of cells;
transmitting a paging message including service availability information and resource availability information to UEs that are located within cells in which the MBMS service is available; and
transmitting, to the UEs within the plurality of cells, a service availability message including resource availability information about at least one MBMS service available in each of the cells.

2. The method of claim 1, wherein the service availability message further includes service type information of the at least one MBMS service, if the resource availability information is set to true.

3. The method of claim 2, wherein the service type information is one of PtP (Point-to-Point), PtM (Point-to-Multipoint), and no UE,
wherein the PtP indicates that the at least one MBMS service is provided in a PtP mode, the PtM indicates that the at least one MBMS service is provided in a PtM mode, and the no UE indicates that no UEs request the MBMS service within a cell.

4. The method of claim 1, wherein the step of transmitting the service availability message comprises the step of periodically transmitting the service availability message on an MBMS control channel during the at least one MBMS service.

5. The method of claim 1, wherein the paging message further includes session start information indicating a start of the MBMS service and a counting parameter for counting UEs to receive the MBMS service, if the service availability information is set to true and the resource availability information is set to true.

6. A method of receiving service availability information about an MBMS (Multimedia BroadcastlMulticast Service) service from an RNC (Radio Network Controller) for controlling UEs (User Equipments) in a plurality of cells, in a UE to receive the MBMS service, the method comprising the steps of:
receiving, from the RNC, a service availability message including service availability information and resource availability information about at least one MBMS service available in a cell in which the UE is located;
determining from the service availability message if a desired MBMS service is available and if there are sufficient resources for the desired MBMS service in the cell; and
receiving the desired MBMS service in the cell, if the desired MBMS service is available and the sufficient resources exist for the desired MBMS service in the cell.

7. The method of claim 6, wherein the service availability message further includes service type information of the at least one MBMS service, if the resource availability information is set to true.

8. The method of claim 7, wherein the service type information is one of PtP (Point-to-Point), PtM (Point-to-Multipoint), and no UE,
wherein the PtP indicates that the at least one MBMS service is provided in a PtP mode, the PtM indicates that the at least one MBMS service is provided in a PtM mode, and the no UE indicates that no UEs request the MBMS service within the cell.

9. The method of claim 6, wherein the step of receiving the service availability message comprises the step of periodically receiving the service availability message on an MBMS control channel during the at least one MBMS service in the cell.

10. The method of claim 7, wherein the step of receiving the desired MBMS service receiving comprises the steps of:
determining if the service availability message includes an identifier (ID) of the desired MBMS service;
checking the resource availability information of the desired MBMS service, if the service availability message includes the ID of the MBMS service; and
receiving the desired MBMS service according to the service type information of the desired MBMS service, if the resource availability information is set to true.

11. The method of claim 10, wherein the step of receiving the desired MBMS service according to the service type information comprises the steps of:
receiving PtM radio bearer information for the desired MBMS service on an MBMS control channel, if the service type information is PtM, and receiving the desired MBMS service on a common channel according to the PtM radio bearer information; and
acquiring PtP radio bearer information for the desired MBMS service, if the service type information is one of PtP and no UE, and receiving the desired MBMS service on a dedicated channel according to the PtP radio bearer information.

12. The method of claim 11, wherein the step of receiving the desired MBMS service on the dedicated channel comprises the steps of:
performing a radio connection setup procedure with the RNC, if the UE is in an idle mode; and
acquiring the PtP radio bearer information by the radio connection.

13. The method of claim 11, wherein the step of receiving the desired MBMS service on the dedicated channel comprises the steps of:
acquiring the PtP radio bearer information by one of a cell update confirm message and a radio bearer setup message received from the RNC, if the UE is in one of a CELL_FACH (Cell_Forward Access Channel) and CELL_PCH (Cell_Paging Channel) state;
performing a cell update procedure with the RNC and acquiring the PtP radio bearer information from the cell update confirm message received from the RNC, if the UE is in a URA_PCH (UTRAN Registration Area_Paging Channel) state; and
performing a handover procedure with the RNC and receiving the Ptp radio bearer information from the RNC on a dedicated control channel, if the UE is in a CELL_DCH (Cell_Dedicated Channel) state.

14. The method of claim 10, wherein the step of receiving the desired MBMS service further comprises the steps of:
moving to another cell capable of providing the desired MBMS service, if the service availability message does not include the ID of the desired MBMS service; and
moving to another cell capable of providing the desired MBMS service, if the resource availability information is set to false.

15. The method of claim 14, wherein the step of receiving the desired MBMS service further comprises the step of performing a routing area update if the service availability message does not include the ID of the desired MBMS service.

16. The method of claim 15, wherein the step of performing the routing area update step comprises the steps of:
determining if the routing area update is needed;
moving to another cell capable of providing the desired MBMS service, if the routing area update is not needed;
requesting a routing update to the RNC and receiving a routing area update confirm message, if the outing area update is needed;
determining if the routing area update confirm message includes service information about at least one MBMS service available in the cell; and
determining if the desired MBMS service is available according to a service availability message received after the routing area update, if the routing area update confirm message does not include the service information.

17. The method of claim 16, wherein the step of performing the routing area update further comprises the steps of:
receiving the desired MBMS service according to the PtP radio bearer information of the desired MBMS service included in the service information, if it is determined that the desired MBMS service is available according to the service information included in the routing area update confirm message; and
selecting another cell capable of providing the desired MBMS service, if it is determined that the desired MBMS service is not available according to the service information.

18. The method of claim 17, wherein the step of performing the routing area update further comprises the steps of:
requesting the desired MBMS service to the RNC, if it is determined that the desired MBMS service is available according to a service availability message received after the routing area update confirm message;
moving to another cell capable of providing the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

19. The method of claim 17, wherein the step of performing the routing area update further comprises the steps of:
requesting the desired MBMS service to the RNC, if it is determined that the desired MBMS service is available according to a service availability message received after the routing area update confirm message;
ending the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

20. The method of claim 16, wherein the step of performing the routing area update further comprises the steps of:
receiving the desired MBMS service according to the PtP radio bearer information of the desired MBMS service included in the service information, if it is determined that the desired MBMS service is available according to the service information included in the routing area update confirm message; and
waiting until resources are available for the desired MBMS service in the cell, if it is determined that the desired MBMS service is not available according to the service information.

21. The method of claim 20, wherein the step of performing the routing area update further comprises the steps of:
requesting the desired MBMS service to the RNC, if it is determined that the desired MBMS service is available according to a service availability message received after the routing area update confirm message;
moving to another cell capable of providing the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

22. The method of claim 20, wherein the step of performing the routing area update further comprises the steps of:
requesting the desired MBMS service to the RNC, if it is determined that the desired MBMS service is available according to a service availability message received after the routing area update confirm message;
ending the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

23. The method of claim 15, wherein the step of performing the routing area update step comprises the steps of:
determining if the routing area update is needed;
waiting until resources are available for the desired MBMS service in the current cell, if the routing area update is not needed;
requesting a routing update to the RNC and receiving a routing area update confirm message, if the outing area update is needed;
determining if the routing area update confirm message includes service information about at least one MBMS service available in the cell; and
determining if the desired MBMS service is available according to a service availability message received after the routing area update, if the routing area update confirm message does not include the service information.

24. The method of claim 23, wherein the step of performing the routing area update further comprises the steps of:
receiving the desired MBMS service according to the PtP radio bearer information of the desired MBMS service included in the service information, if it is determined that the desired MBMS service is available according to the service information included in the routing area update confirm message; and
selecting another cell capable of providing the desired MBMS service, if it is determined that the desired MBMS service is not available according to the service information.

25. The method of claim 24, wherein the step of performing the routing area update further comprises the steps of:
requesting the desired MBMS service to the RNC, if it is determined that the desired MBMS service is available according to a service availability message received after the routing area update confirm message;
moving to another cell capable of providing the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

26. The method of claim 24, wherein the step of performing the routing area update further comprises the steps of:
requesting the desired MBMS service to the RNC, if it is determined that the desired MBMS service is available according to a service availability message received after the routing area update confirm message;
ending the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

27. The method of claim 23, wherein the step of performing the routing area update further comprises the steps of:
receiving the desired MBMS service according to the PtP radio bearer information of the desired MBMS service included in the service information, if it is determined that the desired MBMS service is available according to the service information included in the routing area update confirm message; and
waiting until resources are available for the desired MBMS service in the cell, if it is determined that the desired MBMS service is not available according to the service information.

28. The method of claim 27, wherein the step of performing the routing area update further comprises the steps of:
requesting the desired MBMS service to the RNC, if it is determined that the desired MBMS service is available according to a service availability message received after the routing area update confirm message;
moving to another cell capable of providing the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

29. The method of claim 27, wherein the step of performing the routing area update further comprises the steps of:
requesting the desired MBMS service to the RNC, if it is determined that the desired MBMS service is available according to a service availability message received after the routing area update confirm message;
ending the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

30. The method of claim 20, wherein the step of waiting comprises the step of periodically monitoring an MBMS-related paging channel in the cell.

31. The method of claim 10, wherein the step of receiving the desired MBMS service further comprises the steps of:
ending reception of the desired MBMS service, if the service availability message does not include the ID of the desired MBMS service; and
moving to another cell capable of providing the desired MBMS service, if the resource availability information is set to false.

32. The method of claim 31, wherein the step of receiving the desired MBMS service further comprises the step of performing a routing area update if the service availability message does not include the ID of the desired MBMS service.

33. The method of claim 32, wherein the step of performing the routing area update step comprises the steps of:
determining if the routing area update is needed;
moving to another cell capable of providing the desired MBMS service, if the routing area update is not needed;
requesting a routing update to the RNC and receiving a routing area update confirm message, if the outing area update is needed;
determining if the routing area update confirm message includes service information about at least one MBMS service available in the cell; and
determining if the desired MBMS service is available according to a service availability message received after the routing area update, if the routing area update confirm message does not include the service information.

34. The method of claim 33, wherein the step of performing the routing area update further comprises the steps of:
receiving the desired MBMS service according to the PtP radio bearer information of the desired MBMS service included in the service information, if it is determined that the desired MBMS service is available according to the service information included in the routing area update confirm message; and
selecting another cell capable of providing the desired MBMS service, if it is determined that the desired MBMS service is not available according to the service information.

35. The method of claim 34, wherein the step of performing the routing area update further comprises the steps of:
requesting the desired MBMS service to the RNC, if it is determined that the desired MBMS service is available according to a service availability message received after the routing area update confirm message;
moving to another cell capable of providing the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

36. The method of claim 34, wherein the step of performing the routing area update further comprises the steps of:
requesting the desired MBMS service to the RNC, if it is determined that the desired MBMS service is available according to a service availability message received after the routing area update confirm message;
ending the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

37. The method of claim 33, wherein the step of performing the routing area update further comprises the steps of:
receiving the desired MBMS service according to the PtP radio bearer information of the desired MBMS service included in the service information, if it is determined that the desired MBMS service is available according to the service information included in the routing area update confirm message; and
waiting until resources are available for the desired MBMS service in the cell, if it is determined that the desired MBMS service is not available according to the service information.

38. The method of claim 37, wherein the step of performing the routing area update further comprises the steps of:
requesting the desired MBMS service to the RNC, if it is determined that the desired MBMS service is available according to a service availability message received after the routing area update confirm message;
moving to another cell capable of providing the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

39. The method of claim 37, wherein the step of performing the routing area update further comprises the steps of:
requesting the desired MBMS service to the RNC, if it is determined that the desired MBMS service is available according to a service availability message received after the routing area update confirm message;
ending the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

40. The method of claim 32, wherein the step of performing the routing area update step comprises the steps of:
determining if the routing area update is needed;
waiting until resources are available for the desired MBMS service in the current cell, if the routing area update is not needed;
requesting a routing update to the RNC and receiving a routing area update confirm message, if the outing area update is needed;
determining if the routing area update confirm message includes service information about at least one MBMS service available in the cell; and
determining if the desired MBMS service is available according to a service availability message received after the routing area update, if the routing area update confirm message does not include the service information.

41. The method of claim 40, wherein the step of performing the routing area update further comprises the steps of:
receiving the desired MBMS service according to the PtP radio bearer information of the desired MBMS service included in the service information, if it is determined that the desired MBMS service is available according to the service information included in the routing area update confirm message; and
selecting another cell capable of providing the desired MBMS service, if it is determined that the desired MBMS service is not available according to the service information.

42. The method of claim 41, wherein the step of performing the routing area update further comprises the steps of:
requesting the desired MBMS service to the RNC, if it is determined that the desired MBMS service is available according to a service availability message received after the routing area update confirm message;
moving to another cell capable of providing the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

43. The method of claim 41, wherein the step of performing the routing area update further comprises the steps of:
requesting the desired MBMS service to the RNC, if it is determined that the desired MBMS service is available according to a service availability message received after the routing area update confirm message;
ending the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

44. The method of claim 40, wherein the step of performing the routing area update further comprises the steps of:
receiving the desired MBMS service according to the PtP radio bearer information of the desired MBMS service included in the service information, if it is determined that the desired MBMS service is available according to the service information included in the routing area update confirm message; and
waiting until resources are available for the desired MBMS service in the cell, if it is determined that the desired MBMS service is not available according to the service information.

45. The method of claim 44, wherein the step of performing the routing area update further comprises the steps of:
requesting the desired MBMS service to the RNC, if it is determined that the desired MBMS service is available according to a service availability message received after the routing area update confirm message;
moving to another cell capable of providing the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

46. The method of claim 44, wherein the step of performing the routing area update further comprises the steps of:
requesting the desired MBMS service to the RNC, if it is determined that the desired MBMS service is available according to a service availability message received after the routing area update confirm message;
ending the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

47. The method of claim 37, wherein the step of waiting comprises the step of periodically monitoring an MBMS-related paging channel in the cell.

48. The method of claim 10, wherein the step of receiving the desired MBMS service further comprises the steps of:
ending reception of the desired MBMS service, if the service availability message does not include the ID of the desired MBMS service; and
waiting until resources are available for the desired MBMS service in the cell, if the resource availability information is set to false.

49. The method of claim 48, wherein the step of receiving the desired MBMS service further comprises the step of performing a routing area update if the service availability message does not include the ID of the desired MBMS service.

50. The method of claim 49, wherein the step of performing the routing area update step comprises the steps of:
determining if the routing area update is needed;
moving to another cell capable of providing the desired MBMS service, if the routing area update is not needed;
requesting a routing update to the RNC and receiving a routing area update confirm message, if the outing area update is needed;
determining if the routing area update confirm message includes service information about at least one MBMS service available in the cell; and
determining if the desired MBMS service is available according to a service availability message received after the routing area update, if the routing area update confirm message does not include the service information.

51. The method of claim 50, wherein the step of performing the routing area update further comprises the steps of:
receiving the desired MBMS service according to the PtP radio bearer information of the desired MBMS service included in the service information, if it is determined that the desired MBMS service is available according to the service information included in the routing area update confirm message; and
selecting another cell capable of providing the desired MBMS service, if it is determined that the desired MBMS service is not available according to the service information.

52. The method of claim 51, wherein the step of performing the routing area update further comprises the steps of:
requesting the desired MBMS service to the RNC, if it is determined that the desired MBMS service is available according to a service availability message received after the routing area update confirm message;
moving to another cell capable of providing the desired MBMS service, f it is determined that the desired MBMS service is not available according to he service availability message received after the routing area update confirm essage; and
receiving, if a radio bearer setup message including PtP radio bearer nformation of the desired MBMS service is received after the routing area pdate confirm message, the desired MBMS service according to the PtP radio earer information.

53. The method of claim 51, wherein the step of performing the outing area update further comprises the steps of:
requesting the desired MBMS service to the RNC, if it is determined that he desired MBMS service is available according to a service availability essage received after the routing area update confirm message;
ending the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

54. The method of claim 50, wherein the step of performing the routing area update further comprises the steps of:
receiving the desired MBMS service according to the PtP radio bearer information of the desired MBMS service included in the service information, if it is determined that the desired MBMS service is available according to the service information included in the routing area update confirm message; and
waiting until resources are available for the desired MBMS service in the cell, if it is determined that the desired MBMS service is not available according to the service information.

55. The method of claim 54, wherein the step of performing the routing area update further comprises the steps of:
requesting the desired MBMS service to the RNC, if it is determined that the desired MBMS service is available according to a service availability message received after the routing area update confirm message;
moving to another cell capable of providing the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

56. The method of claim 54, wherein the step of performing the routing area update further comprises the steps of:
requesting the desired MBMS service to the RNC, if it is determined that the desired MBMS service is available according to a service availability message received after the routing area update confirm message;
ending the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

57. The method of claim 49, wherein the step of performing the routing area update step comprises the steps of:
determining if the routing area update is needed;
waiting until resources are available for the desired MBMS service in the current cell, if the routing area update is not needed;
requesting a routing update to the RNC and receiving a routing area update confirm message, if the outing area update is needed;
determining if the routing area update confirm message includes service information about at least one MBMS service available in the cell; and
determining if the desired MBMS service is available according to a service availability message received after the routing area update, if the routing area update confirm message does not include the service information.

58. The method of claim 57, wherein the step of performing the routing area update further comprises the steps of:
receiving the desired MBMS service according to the PtP radio bearer information of the desired MBMS service included in the service information, if it is determined that the desired MBMS service is available according to the service information included in the routing area update confirm message; and
selecting another cell capable of providing the desired MBMS service, if it is determined that the desired MBMS service is not available according to the service information.

59. The method of claim 58, wherein the step of performing the routing area update further comprises the steps of:
requesting the desired MBMS service to the RNC, if it is determined that the desired MBMS service is available according to a service availability message received after the routing area update confirm message;
moving to another cell capable of providing the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

60. The method of claim 58, wherein the step of performing the routing area update further comprises the steps of:
requesting the desired MBMS service to the RNC, if it is determined that the desired MBMS service is available according to a service availability message received after the routing area update confirm message;
ending the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

61. The method of claim 57, wherein the step of performing the routing area update further comprises the steps of:
receiving the desired MBMS service according to the PtP radio bearer information of the desired MBMS service included in the service information, if it is determined that the desired MBMS service is available according to the service information included in the routing area update confirm message; and
waiting until resources are available for the desired MBMS service in the cell, if it is determined that the desired MBMS service is not available according to the service information.

62. The method of claim 61, wherein the step of performing the routing area update further comprises the steps of:
requesting the desired MBMS service to the RNC, if it is determined that the desired MBMS service is available according to a service availability message received after the routing area update confirm message;
moving to another cell capable of providing the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

63. The method of claim 61, wherein the step of performing the routing area update further comprises the steps of:
requesting the desired MBMS service to the RNC, if it is determined that the desired MBMS service is available according to a service availability message received after the routing area update confirm message;
ending the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

64. The method of claim 54, wherein the step of waiting comprises the step of periodically monitoring an MBMS-related paging channel in the cell.

65. The method of claim 10, wherein the step of receiving the desired MBMS service further comprises the steps of:
moving to another cell capable of providing the desired MBMS service, if the service availability message does not include the ID of the desired MBMS service; and
waiting until resources are available for the desired MBMS service in the cell, if the resource availability information is set to false.

66. The method of claim 65, wherein the step of receiving the desired MBMS service further comprises the step of performing a routing area update if the service availability message does not include the ID of the desired MBMS service.

67. The method of claim 66, wherein the step of performing the routing area update step comprises the steps of:
determining if the routing area update is needed;
moving to another cell capable of providing the desired MBMS service, if the routing area update is not needed;
requesting a routing update to the RNC and receiving a routing area update confirm message, if the outing area update is needed;
determining if the routing area update confirm message includes service information about at least one MBMS service available in the cell; and
determining if the desired MBMS service is available according to a service availability message received after the routing area update, if the routing area update confirm message does not include the service information.

68. The method of claim 67, wherein the step of performing the routing area update further comprises the steps of:
receiving the desired MBMS service according to the PtP radio bearer information of the desired MBMS service included in the service information, if it is determined that the desired MBMS service is available according to the service information included in the routing area update confirm message; and
selecting another cell capable of providing the desired MBMS service, if it is determined that the desired MBMS service is not available according to the service information.

69. The method of claim 68, wherein the step of performing the routing area update further comprises the steps of:
requesting the desired MBMS service to the RNC, if it is determined that the desired MBMS service is available according to a service availability message received after the routing area update confirm message;
moving to another cell capable of providing the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

70. The method of claim 68, wherein the step of performing the routing area update further comprises the steps of:
requesting the desired MBMS service to the RNC, if it is determined that the desired MBMS service is available according to a service availability message received after the routing area update confirm message;
ending the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

71. The method of claim 67, wherein the step of performing the routing area update further comprises the steps of:
receiving the desired MBMS service according to the PtP radio bearer information of the desired MBMS service included in the service information, if it is determined that the desired MBMS service is available according to the service information included in the routing area update confirm message; and
waiting until resources are available for the desired MBMS service in the cell, if it is determined that the desired MBMS service is not available according to the service information.

72. The method of claim 71, wherein the step of performing the routing area update further comprises the steps of:
requesting the desired MBMS service to the RNC, if it is determined that the desired MBMS service is available according to a service availability message received after the routing area update confirm message;
moving to another cell capable of providing the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

73. The method of claim 71, wherein the step of performing the routing area update further comprises the steps of:
requesting the desired MBMS service to the RNC, if it is determined that the desired MBMS service is available according to a service availability message received after the routing area update confirm message;
ending the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

74. The method of claim 66, wherein the step of performing the routing area update step comprises the steps of:
determining if the routing area update is needed;
waiting until resources are available for the desired MBMS service in the current cell, if the routing area update is not needed;
requesting a routing update to the RNC and receiving a routing area update confirm message, if the outing area update is needed;
determining if the routing area update confirm message includes service information about at least one MBMS service available in the cell; and
determining if the desired MBMS service is available according to a service availability message received after the routing area update, if the routing area update confirm message does not include the service information.

75. The method of claim 74, wherein the step of performing the routing area update further comprises the steps of:
receiving the desired MBMS service according to the PtP radio bearer information of the desired MBMS service included in the service information, if it is determined that the desired MBMS service is available according to the service information included in the routing area update confirm message; and
selecting another cell capable of providing the desired MBMS service, if it is determined that the desired MBMS service is not available according to the service information.

76. The method of claim 75, wherein the step of performing the routing area update further comprises the steps of:
requesting the desired MBMS service to the RNC, if it is determined that the desired MBMS service is available according to a service availability message received after the routing area update confirm message;
moving to another cell capable of providing the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

77. The method of claim 75, wherein the step of performing the routing area update further comprises the steps of:
requesting the desired MBMS service to the RNC, if it is determined that the desired MBMS service is available according to a service availability message received after the routing area update confirm message;
ending the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

78. The method of claim 74, wherein the step of performing the routing area update further comprises the steps of:
receiving the desired MBMS service according to the PtP radio bearer information of the desired MBMS service included in the service information, if it is determined that the desired MBMS service is available according to the service information included in the routing area update confirm message; and
waiting until resources are available for the desired MBMS service in the cell, if it is determined that the desired MBMS service is not available according to the service information.

79. The method of claim 78, wherein the step of performing the routing area update further comprises the steps of:
requesting the desired MBMS service to the RNC, if it is determined that the desired MBMS service is available according to a service availability message received after the routing area update confirm message;
moving to another cell capable of providing the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

80. The method of claim 78, wherein the step of performing the routing area update further comprises the steps of:
requesting the desired MBMS service to the RNC, if it is determined that the desired MBMS service is available according to a service availability message received after the routing area update confirm message;
ending the desired MBMS service, if it is determined that the desired MBMS service is not available according to the service availability message received after the routing area update confirm message; and
receiving, if a radio bearer setup message including PtP radio bearer information of the desired MBMS service is received after the routing area update confirm message, the desired MBMS service according to the PtP radio bearer information.

81. The method of claim 71, wherein the step of waiting comprises the step of periodically monitoring an MBMS-related paging channel in the cell.

82. The method of claim 6, wherein the service availability message receiving step comprises the steps of:
receiving system information on a broadcast channel;
determining if the system information includes configuration information of the MBMS control channel;
receiving a radio bearer information message on the MBMS control channel using the configuration information, if the system information includes the configuration information of the MBMS control channel, and determining if the radio bearer information message includes the ID of the desired MBMS service; and
receiving the service availability message on the MBMS control channel, if the radio bearer information message includes the ID of the desired MBMS service.
